(19) United States
(12) Patent Application Publication
(10) Pub. No.: US 2008/0242778 A1
(43) Pub. Date: Oct. 2, 2008

(54) Method For Purification And Modification Of Mineral Clays In Non-Aqueous Solvents

(76) Inventors: Stephen Daren, Nes-Ziona (IL); Faina Solomon-Tsvetkov, Tel-Aviv (IL); Vladimir Melnikov, Rehovot (IL); Michael Peled, Be'er Sheva (IL)

Correspondence Address: NATH & ASSOCIATES, 112 South West Street, Alexandria, VA, 22314, US

(21) Appl. No.: 11/658,454

(22) PCT Filed: Jul. 26, 2005
(86) PCT No.: PCT/IL05/00795

§ 371 Date: Dec. 11, 2007

Related U.S. Application Data
(60) Provisional application No. 60/591,945, filed on Jul. 29, 2004.
(60) Provisional application No. 60/668,087, filed on Apr. 5, 2005.

(51) Int. Cl. C09K 3/00

(52) U.S. Cl. 524/261; 252/182.12

(57) ABSTRACT

The present invention discloses a method for obtaining organoclay from crude mineral clay, an organoclay obtainable by this method, a method for incorporating organoclay into a polymeric matrix to obtain composites, and some composites obtainable by this method. The method for obtaining organoclay includes reacting crude mineral clay with quaternary ammonium or phosphonium salt in a non-aqueous solvent to obtain ion-exchanged organoclay suspended in this solvent and a solid residue; and separating out the solid residue. The solvent is then separated, preferably by evaporation or filtration.

### FIELD OF THE INVENTION

This invention relates to a method for purification and modification of mineral clays, organoclays obtained by the method, a method for obtaining a composite of a polymer with the organoclay, and composites obtained thereby.

### BACKGROUND OF THE INVENTION

The known technology utilized for the purification and modification of clays, involves using very large volumes of water and heavy machinery that are both expensive and damaging to the surroundings. The purification step is in fact the major contributor to the cost of organoclays.

In order to obtain pure grades of mineral clays with >99% smectite content, it is necessary to remove impurities such as quartz and calcite from the crude mineral. This is achieved by various wet processes in water, such as washing, separating, drying and grinding. It is usual practice in an additional step to replace all calcium ions on the clay surface by sodium ions by mixing or washing with an excess of a sodium salt. These are all water and energy intensive operations that add greatly to the cost of the clay.

Typically, the purified clay is then dispersed or swollen in water at a concentration of 1-2% by weight after which a quantity of quaternary ammonium or phosphonium salt (hereinafter onium salts) sufficient to exchange all or most of the sodium cations on the clay surface, is added. After a few hours, the organoclay precipitates and then it may be separated from the water by centrifugation or filtration. Examples of such processes are disclosed in U.S. Pat. Nos. 4,517,112 and 5,747,403.

JP2917440B2 describes a modified mineral clay that was prepared by dispersing mineral clay in acetone containing tetraalkyl ammonium hydroxide. However, this procedure was only successful with quaternary ammonium hydroxides and failed with quaternary ammonium bromides and perchlorates.

US 2004/0087700 describes a hybrid organoclay that consists of an organic chemical/phyllosilicate clay intercalate that has been ion-exchanged with quaternary ammonium compounds, and explains, that since this hybrid organoclay is hydrophobic, it can be washed in water to remove reaction salts and excess water soluble or water dispersible polymers to give a clean product via inexpensive means such as filtration.

During the past decade, a great effort has been made to incorporate organoclays into polymeric matrices.

In U.S. Pat. No. 6,656,995 a method is described whereby a quaternary ammonium modified organoclay is dissolved in organic solvents such as xylene or toluene and contacted with polyolefin polymers also in solution. After removal of the solvent, composites with improved melt strength were obtained. In this patent only purified commercially available organoclays were used and no element of mineral clay purification was taught.

### SUMMARY OF THE INVENTION

The inventors have surprisingly found that it is possible in a one-pot operation to render crude mineral clay into purified organophilic clay (hereinafter organoclay or ion-exchanged organoclay), separate out impurities and perform the first step of polymer exfoliation. The process of the invention is suitable for all organo-soluble onium salts and for any polymer with a common or miscible solvent with the organoclay.

Thus, the present invention provides, according to a first aspect thereof, a process comprising reacting crude mineral clay containing impurities with quaternary ammonium or phosphonium salts in non-aqueous solvent to obtain ion-exchanged organoclay suspended in said non-aqueous solvent and a solid residue containing said impurities; and separating out said solid residue, for example by filtration, settling, centrifugation, or decantation. Such process allows for purifying crude mineral clay to obtain a suspension of purified ion-exchanged organoclay.

Further, said process may be continued in several ways:

According to one embodiment, the suspension of the purified ion-exchanged organoclay is mixed with a polymer such as polystyrene, polyacrylate or polyolefin etc, as to obtain the organoclay in a polymeric matrix. The polymer may be dissolved in a solvent, which is the same as or different from the solvent suspending the organoclay.

The polymer solution and the organoclay suspension are mixed together until homogeneous, and then the solvents may be removed. The relatively low viscosity of the polymer solution and the swelling of the organoclay in its solvent, facilitate the dispersion of the clay platelets among the polymer chains. This dispersion is largely maintained even after the solvent has been removed.

According to another embodiment, the solvent may be removed from the suspension of the purified ion-exchanged organoclay, for example, by evaporation or by filtration, to obtain a non-suspended organoclay.

The non-suspended organoclay may be further processed by mixing it with a polymer in the presence of a solvent as to obtain the organoclay in a polymeric matrix. This may be especially advantageous if the solvent used for purifying the crude mineral clay is different from that used for mixing the organoclay with the polymer, or when the purified organoclay should be stored before it is further processed as to obtain an organoclay in a polymeric matrix.

One example of a non-aqueous solvent is a polyol. Where polyol is used as the non-aqueous solvent, the suspension may be mixed and reacted with isocyanate in the presence of suitable catalyst, such as an amine catalyst, to obtain a composite of polyurethane with the organoclay.

Non-limiting Examples of isocyanates, useful in accordance with the invention, are di- or tri-isocyanates, such as toluene-diisocyanate (TDI) and diphenyl methane diisocyanate (MDI).

According to another embodiment, the non-aqueous solvent is a reactive monomer, such as styrene, and the process further comprises polymerization of the monomer to obtain a composite comprising the product of said polymerization. The non-aqueous solvent may include two or more different monomers, such that the product of the polymerization is a copolymer.

In the present description and claims, a reactive monomer is a compound capable of being polymerized. A reactive monomer may be activated by heating, chemical initiation such as peroxides or strong acids, radiative initiation such as ultraviolet light and any other polymerization procedure known to those familiar in the art.

Non-limiting examples of reactive monomers are styrene, methyl methacrylate, vinylidene chloride, vinyl acetate, divinyl benzene and other monomers that are liquid at room temperature.

In any of the processes of the invention the onium salt described above may in practice be a mixture of more than one onium salt, and similarly, the solvent may be a mixture of more than one substance.

Preferably said onium salt has an anion that is a halide, perchlorate, or perbromate. Preferable halides are chloride and bromide. Hydroxides are possible, but not preferable, as they are usually thermally unstable.

A process of the present invention may be carried out at any temperature from room temperature to about 170° C. Preferably, the process is carried out at room temperature, and if at higher temperature, an upper limit of 70° C. is preferred.

Also provided by the present invention is the organoclay obtained by the above-described process. This clay may be distinguished from prior art organoclays in that it contains trace amounts of the non-aqueous solvent used in the purification method. These trace amounts are about 1% w/w if no specific effort is made to reduce them, and the inventors found that such an effort may bring them to levels of about 40 ppm.

For many purposes the solvents may be removed, for instance by evaporation or filtration, but it may also be possible to use the polymer-organoclay suspension obtained in the process as such, namely, without removal or only with partial removal of the solvent. Such suspension may be used for example, as ink for ink-jet printing, to obtain fine powder of the polymer-clay intercalate, for instance, by spray drying, and to obtain cast film, as specifically described in Example 8 below.

The polymers that may be used in accordance with the invention include homopolymers, copolymers, terpolymers, etc. Non-limiting examples of polymers that may be used in accordance with the invention are polyolefins, polystyrene, polyvinylidene chloride, polyvinyl chloride, polyamides, EVA (ethylene vinyl acetate), acrylates and copolymers thereof.

The weight ratio of the organoclay in the entire composition (namely, out of organoclay and the polymer combined) may be between about 1% and about 99%, preferably between about 10% and about 80%, more preferably between about 30% and about 70%, and most preferably about 50%.

Also provided by the invention is a composite comprising organoclay in a polymeric matrix, the composite includes traces of non-aqueous non-aromatic organic solvent. In preferred embodiments of this aspect of the invention the interlaminar distance of the clay platelets is between about 2.5 nm and about 4 nm. When suspended in a solvent at suitable concentrations, the composite may exfoliate to give a nano-composite.

The present invention further provides a composite obtained by a process according to the invention. Such a composite may be composed of organoclay in a polymeric matrix and include traces of non-aqueous non-aromatic organic solvent.

Composites in accordance with the invention may be obtained with polymers of practically any given molecular weight, including those that are difficult to handle by prior art methods due to their high viscosity.

As composites of the invention may be prepared from organoclays purified as provided herein, they may contain traces of the non-aqueous solvent used in the processes of the invention.

### DETAILED DESCRIPTION OF THE INVENTION

As summarized above, in accordance with the present invention, crude mineral clay and a quaternary ammonium or phosphonium salt are stirred together in a non-aqueous solvent. After a few hours, when the ion exchange between the surface cations of the clay and the onium ion has occurred, the solution is allowed to stand. The non-smectite impurities in the clay such as quartz, free metals such as iron, the sodium salt formed as a result of the ion exchange, and any non-reacted clay, all settle to the bottom of the vessel. A simple operation of filtration or decantation may be sufficient for separating the organoclay suspension from the various impurities. The solvent may then be evaporated or filtered to yield organoclays essentially free from impurities. The organoclays prepared in this manner may be identified by the presence of residual solvent.

The term crude mineral clay refers to mineral clays as they are mined or after partial cleaning, as, for example, montmorillonites containing 2-7% non-smectite impurities, sold by Laviosa Chimica Mineraria S.p.A., Italy.

Non-limiting examples of mineral clays that may be purified in accordance with the invention are smectite clays such as montmorillonite, bentonite, hectorite, saponite, stevensite, beidellite. These clays are chemically defined, for example, in US 2004-0087700 paragraphs 41 to 52, incorporated herein by reference.

The quaternary ammonium or phosphonium cation should be hydrophobic enough to dissolve in the non-aqueous medium where it is reacted with the clay. Such ions should have at least about 25 carbon atoms, of which at least 8 are interconnected as to create a single chain. Preferably, the cation contains between 25 and 60 carbon atoms. Non-limiting examples of such onium ions are mentioned in US 2004-0087700 in paragraphs 60 to 66, incorporated herein by reference, and in the examples described below.

The non-aqueous solvent in accordance with the invention is preferably an organic solvent that creates a solution with the onium salt and a colloidal suspension (possibly translucent) with the ion-exchanged organoclay obtained in the process of the invention. Non-limiting examples of such non-aqueous substances are styrene, toluene, xylene, cyclohexane, ethers, halogenated aliphatic and aromatic hydrocarbons, cyclic ethers, DMF (N,N-dimethylformamide) and polyols.

The term polyol as used herein refers to any material having several hydroxyl groups such as polyethylene glycol, polypropylene glycol, saccharides, polysaccharides and the like.

When a polyol is used as the non-aqueous solvent in the process of the present invention, the process may be utilized for producing polyurethanes. The specific polyol used, and particularly, the number of hydroxyl groups it has, may be selected in accordance with the intended use of the polyurethane to be produced, as generally known in the art of polyurethane synthesis.

Preferably, the solvent to be removed by distillation has a boiling point lower than 170° C. at atmospheric pressure.

Preferably, the amount of the non-aqueous solvent used in the method of the present invention is about 10 to 30 times (w/w) of that of the crude mineral clay.

In order to understand the invention and to see how it may be carried out in practice, specific embodiments will now be described, by way of non-limiting examples only.

### EXAMPLES

### Example 1

### Preparation of Tetrabutyl Ammonium—Montmorillonite

### Comparative Example in Water

1 litre of 2% suspension of Mineral Colloid MO (purified Na-montmorillonite from Southern Clay, USA) and a solution of tetrabutyl ammonium bromide 7.37 g in 100 ml water were stirred for 5 hours. The reaction mixture was then centrifuged and washed 3 times with water, three times with acetone, once with toluene, filtered, dried at 50-60° C. under vacuum and ground to a powder. The yield was 18.0 g (76.6%). X-ray powder diffraction of the organoclay showed that interlamenar distance, i.e. the distance between two clay platelets, had increased to 1.55 nm compared to 1.24 nm in the unmodified clay.

### Example 2

### Preparation of Tributyltetradecyl Phosphonium Chloride—Montmorillonite in Toluene

5 g of crude montmorillonite clay with a cation exchange capacity (CEC) of 0.96 meq/g (Laviosa, Italy) were placed in 120 g of toluene solution containing 2.6 g tributyltetradecylphosphonium chloride (Cyphos 3453, Cytec). This is equivalent to 1.2 CEC of the clay. The mixture was stirred for 20 hours at room temperature. The organoclay obtained was about 5% by weight in toluene. The suspension was placed in a cylinder and allowed to settle for 24 hours. The upper suspension layer was separated from the sediment by decantation. The solvent was evaporated, and the organoclay was dried at 50-60° C. under vacuum and analyzed (Yield 4.5 g). The sediments were also dried and analyzed (Weight 0.6 g). Comparative EDS analyses of the organoclay, the crude clay and the clay residue showed a decrease in impurities in organoclay especially of calcium, and a corresponding increase of impurities in the residues. X-ray powder diffraction of the organoclay showed the interlamenar distance equal to 2.49 nm and an absence of crystalline impurities such as silica. The residues in contrast, showed an increased amount of crystalline impurities in comparison with initial crude clay. Thus in a single reaction vessel, the crude clay has been purified and intercalated with a quaternary phosphonium salt.

### Example 3

### Preparation of Dimethyldioctadecyl Ammonium Bromide—Montmorillonite in Toluene

5 g of crude montmorillonite clay CEC=1 meq/g (Laviosa, Italy) were placed in a dimethyldioctadecyl ammonium bromide (Aldrich) solution in toluene (3.8 g of quaternary salt in 129 g of toluene). The mixture was stirred for about 24 hours at room temperature. The suspension obtained was placed in a cylinder and allowed to settle for 24 hours. Then the upper suspension layer was separated from the sediment by filtering through a fine cloth. The remaining suspension was filtered via filter paper and the organoclay was dried at 50-60° C. under vacuum and analyzed. X ray Powder Diffraction showed that the interlamenar distance was 3.81 nm.

### Example 4

### Preparation of Aliquat 336—Montmorillonite in Toluene

5 g of crude montmorillonite clay CEC=1.2 meq/g (Laviosa, Italy) were placed in a tricaprylylmethyl ammonium chloride (Aliquat 336) solution in toluene (3.0 g of quaternary salt in 122 g of toluene). The mixture was stirred for about 2 hours at 100° C. and then 18 hours at room temperature. The suspension obtained was placed in a cylinder and allowed to settle for 24 hours. Then the upper suspension layer was separated from the sediment by filtering through a fine cloth. The solvent was evaporated, and the organoclay was dried at 50-60° C. under vacuum and analyzed. X ray Powder Diffraction showed that the interlamenar distance was 2.61 nm.

### Example 5

### Preparation of Tributyltetradecyl Phosphonium—Montmorillonite-Maleated Polypropylene Composite

The upper portion of the organoclay suspension in toluene as prepared in Example 2 was separated and heated to reflux. Then maleated polypropylene (PP-MA) Polybond 3150 (Uniroyal Chemical Company, Inc, USA) was added in an amount equal to the weight of organoclay. After stirring at reflux temperature for three hours, the polymer dissolved. The solvent was evaporated, and the organoclay-PP-MA composite was dried at 50-60° C. under vacuum and analyzed. X ray Powder Diffraction showed the interlamenar distance equal to 2.94 nm.

### Example 6

### Preparation of Arquad 2HT-75—Montmorillonite in Methylene Chloride

5 g of crude montmorillonite clay, CEC=1 meq/g (Laviosa, Italy) were mixed at room temperature with 3.3 g Arquad 2HT-75 (dimethyl dioctadecyl ammonium chloride) in 110 mls methylene chloride for twenty-four hours in accordance with the procedure described in Example 3. X ray powder diffraction showed an interlamenar distance equal to 3.42 nm.

### Example 7

### Preparation of Polystyrene-Arquad 2HT-75 Montmorillonite Composite in Methylene Chloride

To the upper part of a suspension of organoclay with Arquad-2HT-75 in methylene chloride, as prepared in Example 6 were added 100 g of a 5% solution of polystyrene in methylene chloride. After stirring for three hours, the solvent was removed by evaporation and the composite remained. The composite was dried at 50-60° C. under vacuum and analyzed. X ray Powder Diffraction showed the interlamenar distance equal to 3.68 nm.

### Example 8

### Preparation of Food-Wrap Film with Arquad2HT-75 Montmorillonite

The upper part of a suspension of organoclay with Arquad-2HT-75 in methylene chloride, as prepared in Example 6, was added to a 10% solution of poly(vinylidene chloride-co-acrylonitrile-co-methylmethacrylate) in THF in a quantity that brought the organoclay to be 2.5% by weight of the terpolymer. After stirring for three hours, the suspension was cast onto a glass plate. After the solvents had evaporated, an essentially clear film of the type used for food wrap film was obtained.

### Example 9

### Suspensions of Organoclays in Various Solvents

In order to purify a specific organoclay by the method of the present invention, it is necessary to find first a suitable non-aqueous solvent which causes the formation of a suspension or a gel with that organoclay. In the present example, the suitability of 11 different solvents for purifying three different clays was checked as follows:

5% (W/W) suspensions of the organoclays in the respective solvents were shaken for 6-8 hours at ambient temperature. The observation of stability of the obtained colloidal gel/mixture was made about 6 hours after shaking was stopped.

| | Organoclay | | |
|---|---|---|---|
| | | | Clay from |
| Solvent | Cloisite ® 15A | Claytone ® AF | Example 2 |
| Cyclohexane | Suspension | Suspension | suspension |
| Methylene chloride | Gel | Gel | Gel |
| Xylene | Gel | Gel | Gel |
| Chlorobenzene | Gel | Gel | Gel |
| THF | Gel | Gel | suspension |
| MEK | Settling | Settling | settling |
| Ethylacetate | Settling | Settling | settling |
| Acetonitrile | Settling | Settling | settling |
| n-butanol | Settling | Settling | settling |
| Sulfolane | Floating | Floating | floating |
| DMF | Suspension | Suspension | Gel |

The organoclays used are:
1. Cloisite® 15A which is a natural montmorillonite modified with a quaternary ammonium salt dimethyl dihydrogenated Tallow ammonium chloride manufactured by Southern Clay Products, USA;
2. Claytone® AF which is another modified montmorillonite sold by Southern Clay Products in USA. This organoclay is designed for use in aliphatic solvents; and
3. The organoclay of Example 2.

In accordance with the present example, solvents that cause suspension or gel formation of an organoclay may be considered suitable for use in accordance with the method of the present invention with that clay. Solvents in which all the examined clays settle are probably not suitable for use with these clays, but may be used with other clays, or with any of these clays, in a mixture with another solvent.

### Example 10

### Suspension of Montmorillonite in Polyol

5 g of crude montmorillonite clay with a cation exchange capacity (CEC) of 1.0 meq/g (Laviosa, Italy) were placed in 153 g polyol (Rokopol F3600, Rokita SA) with hydroxyl value 45-50 mgKOH/g. Then 2.83 g dimethyldioctadecyl ammonium chloride (Arquad-2HT-75) were added. This is equivalent to 1.2 CEC of the clay. The mixture was stirred for 20 hours at 80-90° C. The organoclay obtained was about 5% by weight in polyol. The suspension was placed in a cylinder and allowed to stand for 5 days. The suspension remained stable. The upper suspension layer was separated from the sediment by decantation. The clay-polyol suspension was used for the preparation of polyurethane foams.

### Example 11

### Suspension of Montmorillonite in Styrene

2.6 g of Arquad HT-75 (Akzo Nobel, USA) (dimethyldioctadecyl ammonium chloride) were dissolved in 95 g of styrene at 30° C. To this solution 5 g of crude montmorillonite clay with a cation exchange capacity (CEC) of 1.0 meq/g (Laviosa, Italy) were added. The ammonium salt is equivalent to 1.0 CEC of the clay. The mixture was stirred for 20 hours at 30° C. The suspension was placed in a cylinder and allowed to stand for 24 hours. The upper suspension layer was separated from the sediment by decantation and polymerized in bulk, in portions of 15 g each, with 75 mg benzoyl peroxide as an initiator under argon at 60° C. for 3 hours followed by 16 hours at 80° C. An opaque block of polystyrene-clay composite was obtained.

In other experiments, 15 g portions of the suspension were polymerized with an addition of 0.3 g of divinylbenzene as a cross-linking agent.

In still other experiments, portions of the obtained suspension were diluted with an equal amount of styrene (7.5 g suspension and 7.5 g of styrene) and polymerized in bulk as described above, to give a composite that was translucent. Alternatively, other monomers such as acrylates that copolymerize well with styrene could be added to produce copolymer composites.

1-43. (canceled)

44. A process comprising: i) reacting crude mineral clay containing impurities with quaternary ammonium or phosphonium salt in non-aqueous solvent to obtain ion-exchanged organoclay suspended in said non-aqueous solvent and a solid residue containing said impurities; and ii) separating out said solid residue.

45. A process according to claim 44, wherein the cation of the quaternary salt has between 25 and 60 carbon atoms, and at least 8 of them are interconnected as to create a single chain.

46. A process according to claim 44, wherein said non-aqueous solvent is selected from styrene, toluene, xylene, cyclohexane, ethers, halogenated aliphatic and aromatic hydrocarbons, cyclic ethers, DMF (N,N-dimethylformamide), chlorobenzene, THF (tetrahydrofuran) and polyols.

47. A process according to claim 44, further comprising removing said non-aqueous solvent.

48. An organoclay obtainable by the process of claim 47.

49. A process according to claim 44, further comprising mixing the obtained suspension of the organoclay with a polymer thereby obtaining a composite of said polymer and said organoclay, the composite being suspended in said solvent.

50. A process according to claim 49, wherein prior to said mixing, said polymer is dissolved in a non-aqueous solvent, being the same or different from the non-aqueous solvent suspending the organoclay.

51. A process according to claim 47, further comprising mixing said ion-exchanged organoclay with a polymer in the presence of at least one non-aqueous solvent.

52. A process according to claim 48, wherein said composite is an intercalate of said polymer and said organoclay.

53. A process according to claim 48, wherein after said mixing, the solvents are removed.

54. A process according to claim 49, wherein after said mixing, the solvents are removed.

55. A process according to claim 49, wherein after said mixing, the solvents are removed.

56. A composite comprising organoclay in a polymeric matrix which includes traces of non-aqueous non-aromatic organic solvent.

57. A composite obtainable by a process according to claim 50.

58. A process according to claim 44, wherein said non-aqueous solvent is a reactive monomer.

59. A process according to claim 56, wherein said reactive monomer is selected from styrene, methyl methacrylate, vinylidene chloride, vinyl acetate, divinyl benzene and other monomers that are liquid at room temperature.
